(19) United States
(12) Patent Application Publication
(10) Pub. No.: US 2020/0068140 A1
(43) Pub. Date: Feb. 27, 2020

(54) NEUTRAL ENVIRONMENT RECORDING DEVICE

(71) Applicant: Benjamin Ee Pao WUNG, Auckland (NZ)

(72) Inventor: Benjamin Ee Pao WUNG, Auckland (NZ)

(21) Appl. No.: 16/344,613

(22) PCT Filed: Oct. 25, 2017
(86) PCT No.: PCT/IB2017/056607

§ 371 Date: Apr. 24, 2019

Related U.S. Application Data
(60) Provisional application No. 62/412,334, filed on Oct. 25, 2016.

(51) Int. Cl. H04N 5/262; G06F 3/01; H04N 13/282; H04N 5/77; H04N 13/398; H04N 13/366; G01C 17/28; G01C 19/00

(52) U.S. Cl. CPC H04N 5/2628; G06F 3/012; H04N 13/282; G01C 19/00; H04N 13/398; H04N 13/366; G01C 17/28; H04N 5/77

(57) ABSTRACT

A neutral environment recording device may include: a camera configured to record images as visual information; a gyroscope sensor configured to measure and communicate position data, orientation data, position change data, and/or orientation change data describing the device as orientation information; a magnetometer configured to measure the direction of the earth's magnetic field at a point in space occupied by the device as orientation information; an accelerometer configured to measure and provide acceleration data describing the device as orientation information; and a processing unit in electrically communication with the camera, gyro-scope, magnetometer, and accelerometer. The processing unit may be configured to record the visual information and the orientation information and to combine the visual information and orientation information to provide a recording which stays true to directional points regardless of how the device is moved, rotated, and orientated.

### FIELD OF THE INVENTION

This patent specification relates to the field of recording devices. More specifically, this patent specification relates to recording devices configured to record visual information and to provide orientation information describing the visual information.

### BACKGROUND

Virtual reality is used to simulate a viewer or user's physical presence in computer-simulated real or imaginary environments. Typically, visual images may be displayed either on a computer screen or through a stereoscopic (e.g., 3D) display, such as a wearable headset when providing virtual reality to a user. Additionally, environmental sounds may be provided through speakers or headphones and force feedback via, for example, a dynamic platform or a vibrating controller or joystick.

Although virtual reality systems provide realistic and immersive environmental experiences, they also are known to cause motion sickness in many users. Motion sickness may occur when the systems of the body responsible for balance, such as the visual system, proprioception system, and the vestibular system, do not agree with each other. Since the brain uses all three of these systems to perceive the motion and orientation of the user, when one system does not agree with the others, a feeling of motion sickness by the user may result.

Virtual reality systems are frequently responsible for visually induced motion sickness which as may occur when motion is perceived visually, such as reproduced on a computer screen or through a stereoscopic display, but the body is physically at rest. Symptoms of motion sickness may include nausea, dizziness, vomiting, and sweating. These symptoms may be even more severe for users of isolating stereoscopic displays which seek to block all frames of reference to the world outside of the stereoscopic display. Motion sickness symptoms are further exacerbated by the inability of the user to control or decide their orientation within the virtual reality environment. Not only does virtual reality induced motion sickness cause physical and emotional distress, but can prevent users from enjoying social interaction which may be afforded by multiplayer virtual reality games, environments, and the like.

Therefore, a need exists for novel neutral environment recording devices which reduce motion sickness or more specifically virtual reality motion sickness. Additionally, there exists a need for novel neutral environment recording devices which are configured to provide the user with the ability to control or decide their orientation within the virtual reality environment.

### BRIEF SUMMARY OF THE INVENTION

A neutral environment recording device is provided which is configured to reduce or eliminate virtual reality motion sickness. In some embodiments the neutral environment recording device may include: a camera configured to record images as visual information; a gyroscope sensor configured to measure and communicate position data, orientation data, position change data, and/or orientation change data describing the device as orientation information; a magnetometer configured to measure the direction of the earth's magnetic field at a point in space occupied by the device as orientation information; an accelerometer configured to measure and provide acceleration data describing the device as orientation information; and a processing unit in electrically communication with the camera, gyroscope, magnetometer, and accelerometer. The processing unit may be configured to record visual information provided by the camera and to record orientation information provided by the gyroscope, magnetometer, and accelerometer. The processing unit may also be configured to combine the visual information and orientation information.

The visual information and orientation information may be combined by the processing unit to provide a recording which stays true to directional points, such as North, East, South, and West, regardless of how the device is moved, rotated, and orientated. When the recording is used to create a virtual reality environment, the user is able to decide viewer orientation of the recording. In this manner, the viewer is able to control which direction they want to look in the virtual reality environment. Viewing direction is therefore not dependent on the recorded video because the recording device always records a neutral environment resulting in the reduction or elimination of virtual reality motion sickness by the user.

The device may optionally include one or more GPS sensors, power sources, control inputs, female plug members, microphones, light emitting elements, indicator elements, and/or memory card readers.

In a first aspect the present invention may be said to consist a neutral environment recording device, the device comprising:
a) a camera configured to record images or video as visual information;
b) a gyroscope sensor configured to measure and communicate position data, orientation data, position change data, and/or orientation change data describing the device as orientation information;
c) a magnetometer configured to measure the direction of the earth's magnetic field at a point in space occupied by the device as orientation information;
d) an accelerometer configured to measure and provide acceleration data; and
e) a processing unit in communication with the camera, gyroscope, magnetometer, and accelerometer, wherein the processing unit is configured to record visual information provided by the camera, wherein the processing unit is configured to record orientation information and data provided by the gyroscope, magnetometer, and accelerometer, and wherein the processing unit is configured to combine the visual information and orientation information so the output visual information has respective orientation information related to it, the processing unit storing the output visual information aligned to an initial reference orientation.

In one embodiment, the processing unit stores the output visual information aligned to an initial reference orientation on the device or associated memory.

In one embodiment, the processing unit streams from the device the output visual information aligned to an initial reference orientation.

In one embodiment, output visual information is aligned to an initial reference orientation.

In one embodiment, output visual information has a field of view aligned to an initial reference orientation.

In one embodiment, the field of view of the output visual information stays aligned to the initial reference orientation, irrespective of the orientation of the recording device at the time of recording.

In one embodiment, the output visual information is streamed or stored with a field of view aligned to the initial reference orientation.

In one embodiment, the output visual information field of view is less than the field of view of the images or video recorded by the camera.

In one embodiment, the output visual information is shifted or stitched to stay aligned to the initial reference orientation.

In one embodiment, the initial reference orientation is a preselected orientation.

In one embodiment, the initial reference orientation is the first orientation of the visual information recorded, streamed or output to a viewer.

In one embodiment, the orientation information is used to determine the difference of orientation between the recorded visual information and the initial reference orientation.

In one embodiment, the position data, orientation data, position change data, and/or orientation change data is used independently or with the magnetometer orientation information to determine the difference of orientation from the recorded visual information to the initial reference orientation.

In one embodiment, a viewer of the output visual information can choose to view output visual information relating to a new reference orientation, the new reference orientation having a change of orientation from the initial reference orientation.

In one embodiment, the viewerviews the output visual information on a projection or screen.

In one embodiment, the field of view of the output visual information is equal to the field of view of the projection or screen.

In one embodiment, the new reference orientation is determined by the shift in orientation of the viewer's head from the initial reference orientation.

In one embodiment, the output visual information is shifted or stitched to stay aligned to the new reference orientation.

In one embodiment, the orientation information is combination at least the horizontal orientation and a vertical orientation from the magnetometer.

In one embodiment, any drift, noise or error in the magnetometer orientation information is able to be corrected or trued by the orientation information from the gyroscope or accelerometer, where the gyroscope or accelerometer data may include any one or more of the position data, orientation data, position change data, orientation change data and acceleration data.

A device as claimed in any one of claims 4 to 20, wherein the initial reference orientation is the orientation of the device at the first instance of recording, or the first orientation of the output visual information.

In a second aspect the present invention may be said to consist a recording and viewing system, the system configured to output recorded video with orientation information to allow a viewer to view a desired orientation of video to view, the system comprising
a) a recording device, to record visual and orientation information, comprising:
b) a camera configured to record images or video as visual information;
c) a gyroscope sensor configured to measure and communicate position data, orientation data, position change data, and/or orientation change data;
d) a magnetometer configured to measure the direction of the earth's magnetic field at a point in space occupied by the device as orientation information;
e) a processing unit in communication with the camera, gyroscope, magnetometer, and accelerometer, wherein the processing unit is configured to process visual information provided by the camera, and to process orientation information and data provided by the gyroscope, magnetometer, and accelerometer, and wherein the processing unit is configured to combine and associate the visual information and orientation information in a streamed or recorded video output; and
f) a viewing device configured to receive preferred viewer orientation information from a viewer and output viewer video, with a field of view, aligned to the viewer's preferred orientation; and
g) a processor, either the processing unit or a further processor, configured to receive the streamed or recorded video output and the preferred viewer orientation information, and output viewer video respective of the viewer's preferred orientation.

In one embodiment, the recording device comprises an accelerometer configured to measure and provide acceleration data to be used in combination with the orientation information.

In one embodiment, the camera is a 360 degree camera, or multiple cameras stitching visual information together to create 360 degree video.

In one embodiment, the video output stays aligned to a specified spatial initial reference orientation, irrespective of the orientation of the recording device at the time of recording.

In one embodiment, the video output stays aligned to a specified spatial initial reference orientation, irrespective of the orientation of the recording device at the time of recording, until an input of preferred viewer orientation information is received by the either the processing unit or the further processor.

In one embodiment, the video output is streamed or stored with a specified field of view.

In one embodiment, the streamed or stored video output has a field of view aligned and centred on the initial reference orientation.

In one embodiment, the video output field of view has a reduced field of view compared to the field of view recorded by the camera.

In one embodiment, the video output is shifted or stitched to stay aligned to the initial reference orientation.

In one embodiment, the viewing device comprises one or more of a screen or projection.

In one embodiment, the viewing device comprises one or more selected from a camera, gyroscope, magnetometer, and accelerometer to determine a preferred orientation of the viewer.

In one embodiment, the preferred orientation of the viewer is the orientation of the viewer; which may be orientation of the viewer's eyes, head, or other body part.

In one embodiment, the viewing device can be manipulated by the viewer to input a preferred orientation of the viewer.

In one embodiment, the viewing device is a stereoscopic headset.

In one embodiment, the viewing device comprises input(s) to receive a viewer's preferred orientation information.

In one embodiment, the input is a mouse, joystick, capacitive button or similar.

In one embodiment, a viewer of the output viewer video or video output can choose to view a new reference orientation, which is different from the initial reference orientation.

In one embodiment, the field of view of the output video is equal to the field of view of the projection or screen.

In one embodiment, the output viewer video is initially aligned to centre the output video's field of view in front of the viewer.

In one embodiment, the new reference orientation is determined by the change in orientation between the preferred orientation of the viewer and the viewer's initial orientation or previous reference orientation, the change in orientation is then compared to the initial reference orientation, and the viewer output video is shifted from the initial reference orientation by the change in orientation.

In one embodiment, the new reference orientation is determined by the preferred orientation, the viewer output video is then shifted from the initial reference orientation or previous reference orientation to the preferred orientation of the viewer.

In one embodiment, the output viewer video is shifted or stitched to stay aligned and to display the output video associated with the new reference orientation.

In one embodiment, the processing unit or further processor corrects roll, pitch and yaw to output a stable and cardinally constant output video with associated orientation information.

In one embodiment, the processing unit or further processor corrects roll, pitch and yaw to output a stable and cardinally constant output viewer video aligned to the viewer's preferred orientation.

In one embodiment, the processing unit or the further processor will continue to output said viewer output video at said viewer preferred orientation until the processing unit or the further processor device receives new preferred viewer orientation information from the viewing device.

In one embodiment, the further processor is located in one selected from the viewing device, the recording device, and an external server.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts a front elevation view of an example of a neutral environment recording device according to various embodiments described herein.

FIG. 2 illustrates a rear elevation view of an example of a neutral environment recording device according to various embodiments described herein.

FIG. 3 shows a top plan view of an example of a neutral environment recording device according to various embodiments described herein.

FIG. 4 depicts a block diagram showing some of the elements of a neutral environment recording device according to various embodiments described herein.

FIG. 5 illustrates a block diagram showing an example processing unit which may be a component of a neutral environment recording device.

FIG. 6 illustrates a block diagram showing a block diagram of the device or system.

FIG. 7 illustrates a block diagram showing an alternative example block diagram of the device or system.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

New recording devices configured to record visual information and to provide orientation information describing the visual information are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

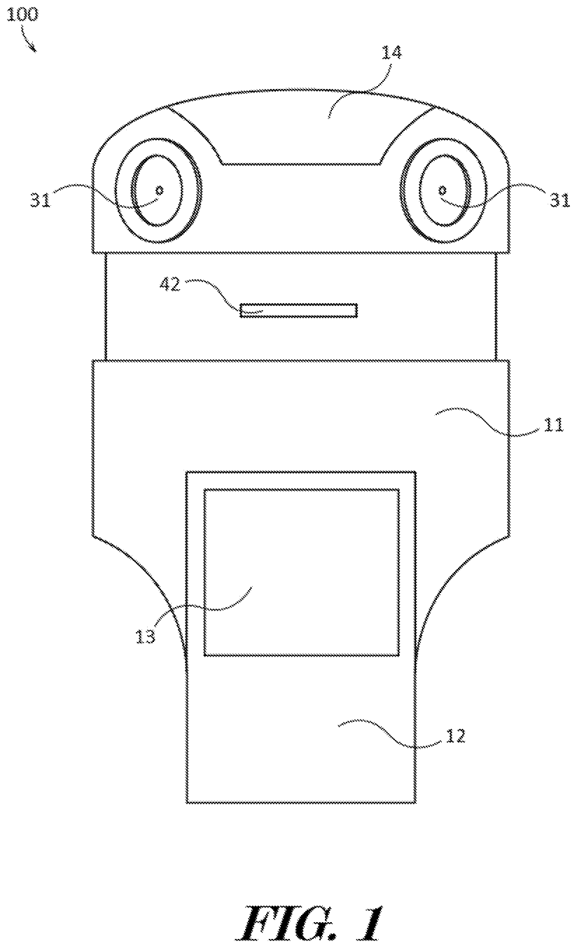

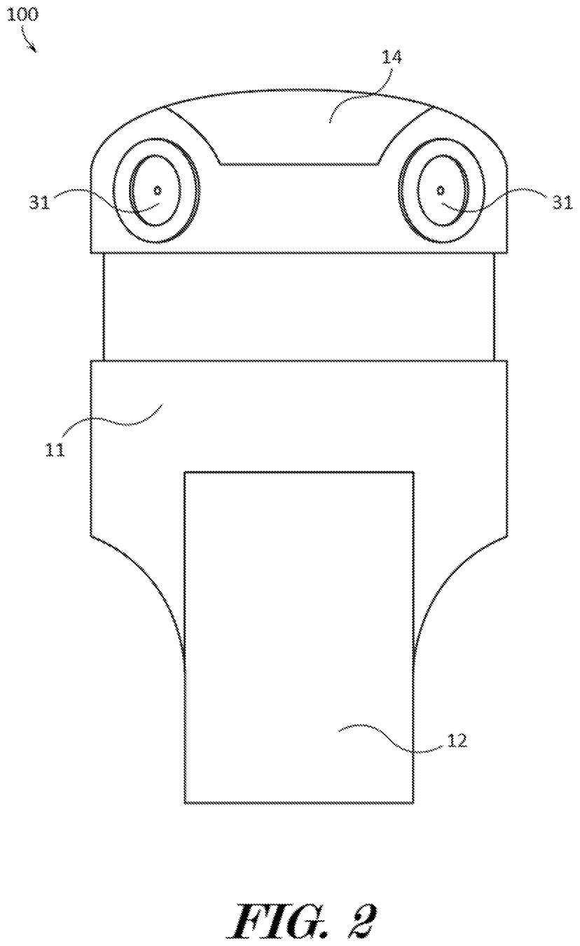

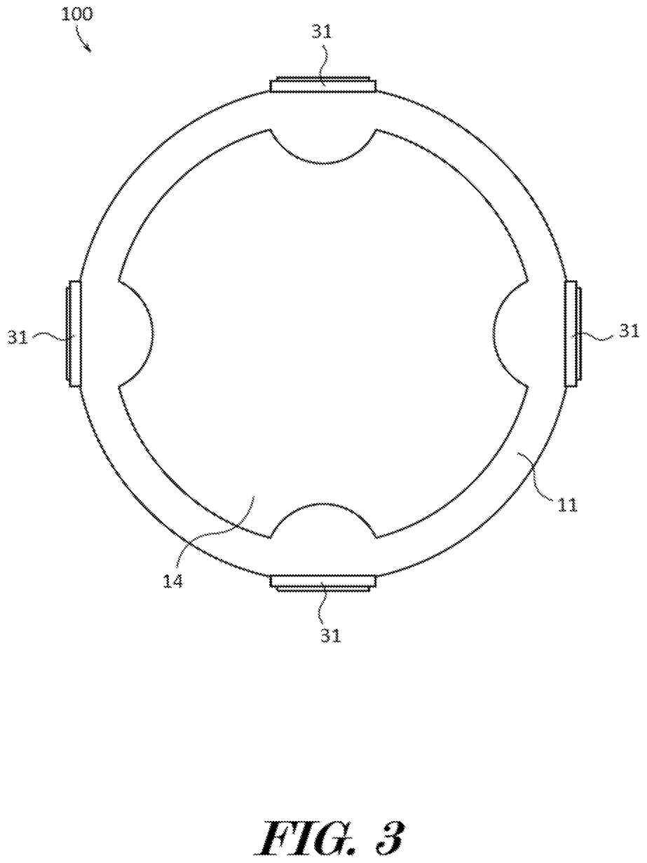

The present invention will now be described by example and through referencing the appended figures representing preferred and alternative embodiments. FIGS. 1-3 illustrate the exterior of an example of a top perspective view of a neutral environment recording device (“the device”) 100 according to various embodiments. In this example, the device 100 comprises a substantially rigid body 11 having an optional top cover 14 and one or more, such as four, cameras 31 which may be coupled to the body 11 and/or to the top cover 14. The body 11 may have a base 12 which may comprise or accept any type of fastener, adhesive, or the like and which may be configured to secure the device 100 to various objects and surfaces. Optionally, the cameras 31 may be disposed towards the top of the body 11 opposingly positioned to the base 12 with each camera 31 oriented so that a 360 degree field of view by the cameras 31 is obtained.

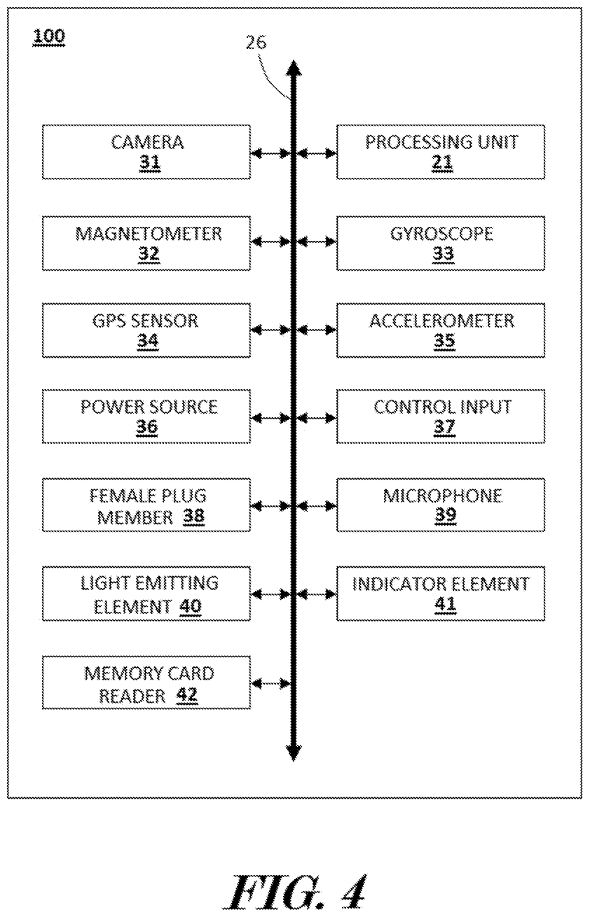

In some embodiments, the body 11 may comprise a battery compartment 13 which may be used to secure a power source 36 (FIG. 4). The battery compartment 13 may comprise a movable door, access panel, or the like which may be used to access a power source 36 within the battery compartment 13.

As shown in the example of FIGS. 1-3, in some embodiments, the body 11 and base 12 may be generally cylindrical in shape with a generally rounded top cover 14. However, it should be understood to one of ordinary skill in the art that the body 11, base 12, battery compartment 13, top cover 14, and an element described herein may be configured in a plurality of sizes and shapes including “T” shaped, “X” shaped, square shaped, rectangular shaped, cylinder shaped, cuboid shaped, hexagonal prism shaped, triangular prism shaped, or any other geometric or non-geometric shape, including combinations of shapes. It is not intended herein to mention all the possible alternatives, equivalent forms or ramifications of the invention. It is understood that the terms and proposed shapes used herein are merely descriptive, rather than limiting, and that various changes, such as to size and shape, may be made without departing from the spirit or scope of the invention.

In some embodiments, the body 11, base 12, battery compartment 13, and top cover 14 may be made from durable and water impervious materials such as hard plastics, ABS plastics, metals and metal alloys including high grade aircraft alloys, wood, hard rubbers, carbon fiber, fiber glass, resins, polymers or any other suitable materials including combinations of materials so that the positioning of the cameras 31 may be maintained during movement of the device 100 and that the battery compartment 13, and top cover 14 preferably may provide a water proof enclosure for the components of the device 100.

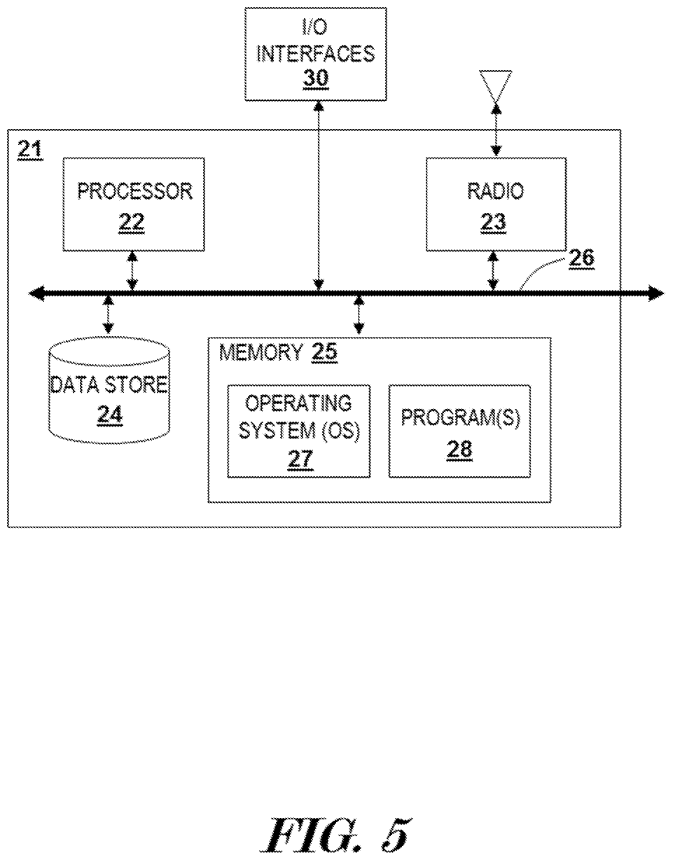

FIG. 4 depicts a block diagram showing some of the elements of a neutral environment recording device 100 according to various embodiments described herein. It should be appreciated by those of ordinary skill in the art that FIG. 4 depicts the device 100 in an oversimplified manner, and a practical embodiment may include additional components or elements and suitably configured processing logic to support known or conventional operating features that are not described in detail herein. In preferred embodiments, the device 100 may comprise a processing unit 21 which may be in communication with one or more optional input/output (I/O) interfaces 30 (FIG. 5) such as a camera 31, magnetometer 32, gyroscope 33, GPS sensor 34, accelerometer 35, and power source 36. In further embodiments, the device 100 may also optionally comprise one or more I/O interfaces 30 which may be configured as a control input 37, female plug member 38, microphone 39, light emitting element 40, indicator element 41, and/or memory card reader 42. The I/O interfaces 30 may be communicatively coupled to the processing unit 21 via a local interface 26.

The device 100 comprises one, two, three, four, five, six, or any number of cameras 31. A camera 31 may be configured to record still images or video images (both known or described as footage) of the environment around the device 100. In preferred embodiments, a camera 31 may comprise a digital camera that encodes images and videos digitally on a charge-coupled device (CCD) image sensor or on a complementary metal-oxide-semiconductor (CMOS) image sensor and stores them for later reproduction. In other embodiments, a camera 31 may comprise any type of camera which includes an optical system, typically using a lens with a variable diaphragm to focus light onto an image pickup device or image sensor. In further embodiments, a camera 31 may comprise a camera with night vision technology such as image intensification, active illumination, and/or thermal imaging capabilities.

A magnetometer 32 may be a measurement device which may measure the direction of the earth's magnetic field at a point in space, such as the point occupied by the device 100. The magnetometer 32 may be configured to provide directional information as to which compass direction one or more cameras 31 of the device 100 are viewing or recording to a processing unit 21. In some embodiments, a magnetometer 32 may comprise a vector magnetometer which is used to measure the vector components of a magnetic field, or a total field magnetometer or scalar magnetometer which is used to measure the magnitude of the vector magnetic field. Preferably, the magnetometer 32 may be used to measure the direction of the Earth's magnetic field and may express the vector components of the field in terms of declination (the angle between the horizontal component of the field vector and magnetic north) and the inclination (the angle between the field vector and the horizontal surface). In further embodiments, a magnetometer 32 may comprise an absolute magnetometer which may measure the absolute magnitude or vector magnetic field, using an internal calibration or known physical constants of the magnetic sensor. In still further embodiments, a magnetometer 32 may comprise a relative magnetometer which may measure magnitude or vector magnetic field relative to a fixed but uncalibrated baseline.

A gyroscope 33 may be configured to measure and communicate position data, orientation data, position change data, and/or orientation change data about the device 100 to a processing unit 21. In preferred embodiments, a gyroscope 33 may comprise a micro electro-mechanical system (MEMS) gyroscope. In other embodiments, a gyroscope 33 may comprise a fiber optic gyroscope (FOG) gyroscope, a hemispherical resonator gyroscope (HRG), a vibrating structure gyroscope (VSG) or a Coriolis Vibratory Gyroscope (CVG), a dynamically tuned gyroscope (DTG), a ring laser gyroscope (RLG), a London moment gyroscope, a tilt sensor such as a MEMS tilt sensor, any other type of tilt sensor, or any other suitable device that is able to measure and electrically communicate tilt data, positional data, and/or orientation data.

A GPS sensor 34 may be configured to receive a global positioning system (GPS) signal and calculate coordinate data for the device 100 and to communicate the data to a processing unit 21. In preferred embodiments, a GPS sensor 34 may comprise GPS logger sensor which may log the position of the device 100 at regular intervals in a memory. In other embodiments, a GPS sensor 34 may comprise a GPS data pusher sensor configured to push or send the position of the device 100 as well as other information like speed or altitude at regular intervals. In further embodiments, a GPS sensor 34 may comprise a GPS data puller sensor or GPS transponder sensor which may be queried for GPS data as often a s required. In still further embodiments, a GPS sensor 34 may comprise any other suitable device or sensor that is able to measure and electrically communicate GPS data.

An accelerometer 35 may be configured to measure and provide acceleration data about the device 100 to a processing unit 21. An accelerometer 35 may comprise any type of accelerometer including capacitive accelerometers, piezoelectric accelerometers, piezoresistive accelerometers, hall effect accelerometers, magnetoresistive accelerometers, heat transfer accelerometers, micro-electro mechanical system (MEMS) accelerometers, NANO technology accelerometers, or any other suitable device that is able to measure acceleration and to electrically communicate acceleration data.

The device 100 is configured to record a neutral recording environment using visual information provided by the one or more cameras 31. The neutral environment recording device records 360-degree video that is able to stay true to either Earth's cardinal direction (North, South, East, West or directions in between) or a fixed reference point in a 360-degree environment.

The neutral recording environment may be achieved by using orientation information which may be provided by one or in combination, a magnetometer 32, gyroscope 33, GPS sensor 34, and/or accelerometer 35. A magnetometer 32 may detect earth's magnetic field so the device 100 always knows which way is North, South, East, West, etc. An accelerometer 35 may detect gravity so the device 100 knows which way is up or down. A gyroscope 33 may detect the rate of rotation (pitch, roll and yaw) so that the device 100 adjusts the recorded footage to always be parallel to the ground. A GPS sensor 34 may provide location, movement, and/or orientation information to the device 100. The visual information provided by the one or more cameras 31 and orientation information provided by a magnetometer 32, gyroscope 33, GPS sensor 34, and/or accelerometer 35.

The visual information and orientation information may be combined by the device 100. The device is able to provide a recording which stays true to cardinal points (North, East, South, West etc. and points in-between—i.e. a spatial direction/orientation) regardless of how the device 100 is moved, rotated, and orientated during recording. When the recording is used to create output footage, for example in a virtual reality environment, the viewer is able to decide viewer orientation of the recording (of the output footage). In this manner, the viewer is able to control which direction of visual information they want to view, or direction (in all axes) to look in the virtual reality environment. Viewing direction is therefore not dependent on the recorded footage because the recording device 100 always records a neutral environment (or at least relates the visual information with the orientation information). So the viewer can choose their own direction to view, or to view the centred output footage that is based on one direction. This results in the reduction or elimination of virtual reality motion sickness by the viewer.

The processing unit of the device outputs visual information preferably in the form of 360 degree video footage by recording and stitching footage using translatory motion principles. Footage is preferably stitched by the processor using these principles while the device is in motion and follows a point along a straight path (rectilinear motion) or a curved path (curvilinear motion). In the case where rotation of the device does not take place during recording, the camera stitches the images together as is, because there is no rotation. However in the case where rotation of the device does take place during recording, the processor analyses each degree of rotation, as measured by the sensors and compensates this rotation by stitching the video footage the measured degree(s) of rotation in the opposite direction to that measured, in order to neutralise the physical rotational effect in the output visual information.

Preferably, the processor utilises the cardinal direction, or heading information received from the magnetometer to determine a fixed reference point to stitch images in relation to. Preferably, other information relating to the orientation of the device such as the yaw, pitch and roll measured by the accelerometer(s) and gyroscope(s) is also used by the processor to compensate for physical movement of the recording device in the visual information outputted by the processor. For example, a reference heading may be set at the start of video recording (or the supplied recording), and any variations away from that heading due to physical rotation of the recording device will be measured by the magnetometer and received by the processor, which will act to stitch the visual information it also receives the appropriate amount in order to maintain the outputted visual information at the initial heading. Similarly, a reference or base reading is made by other sensors such as accelerometer(s) and/or gyroscope(s) at the initialisation of video recording. Physical movement of the device will cause changes in its orientation, which may not be picked up by the magnetometer, such as drift, to be measured by the accelerometer(s) and/or gyroscope(s), and this orientation data is then used in a similar way to the magnetometer data to compensate the differences in the received video information such that the video information outputted by the processor is consistent with the initial orientation of device. An example of the device in use wherein physical movement causes the yaw to be 1-degree left of a fixed point (the initial reference orientation), the processor stitches the received visual information 1-degree right of the fixed reference point, such that the output image provided is at a consistent orientation. FIG. 7 also shows examples where the pitch is 1-degree above the fixed reference point, and the image is stitched 1-degree below the fixed reference point by the processor, and where the device is turned so that roll is 1-degree to the left from the fixed reference point, the processor stitching the received visual information 1-degree to the right of the fixed reference point.

Due to the output stitched video's translatory motion that is fixed to a reference point relating to a cardinal direction, viewers of the footage are able to have total control over which direction (north, south, east, west etc. including directions in-between, and directions up and down) they want to view at any point in time within the duration of the video.

With all 360 degree content in the market today, the viewer has to adhere to the direction that has been set by the recording device. If the recording device turns from north to east (turning right) while filming, the output footage will also mimic that rotational movement, even though the viewer themselves has not moved. In prior art viewers do not have control over which direction they ultimately look, doing so may make them uncomfortable.

Nausea arises in a virtual reality environment when there is a conflict between what a person's eyes see and body feels. This is prevalent in today's VR environment where the viewer has no control over what they see and perceive. By putting this control into the viewer's hands (or eye movement, or head movement), it dramatically reduces nausea. When a viewer wants to turn and look left for example, they have to physically turn their eyes, head or body to face the correct direction. This dispels the conflict between brain and body.

In an alternative embodiment, the processor as defined above may also receive video information and sensed orientation information from an external source. An external source such as: an external video recording/capturing device, which can optionally comprise its own processor adapted to provide the video information and the orientation information from the camera and the sensors; through a memory card which is inserted into the memory card reader of the device; or via a network link such as that provided over the wireless communication 23 preferably forming part of the device.

The processor of the device works as noted in the examples above to stitch the received video information in relation to the orientation information relating to a fixed reference point, such that the processor outputs video information which is consistent with the initial orientation of device throughout the footage. The difference with this being that it receives video information which has been previously obtained from an external source.

In a further embodiment, a system comprising a video recording device and a viewing device which defines the viewers viewing orientation giving the ability to output 360 degree video information which is fixed to the orientation that a viewer can set using the viewing device. The system preferably comprises a recording device which records both visual information and orientation information relating to the orientation and movement of the recording device and which outputs the visual information combined with said orientation information and data. The recording device preferably comprises a camera configured to record images or video as visual information; a gyroscope sensor or sensors configured to measure and communicate position data, orientation data, position change data, and/or orientation change data describing the device as orientation information; a magnetometer(s) configured to measure the direction of the earth's magnetic field at a point in space occupied by the device as orientation information; and an accelerometer(s) configured to measure and provide acceleration data.

The system also preferably comprises a viewing device such as a stereoscopic headset, or display screen such as a tablet or smartphone. The viewing device is configured to sense preferred viewer orientation information from the viewer through sensors such as magnetometer(s), accelerometer(s) and/or gyroscope(s), preferably in combination, or alternatively a camera, which is also preferably used in combination with the sensors. Alternatively, the viewer orientation information can be set through the use of a mouse, joystick, capacitive buttons, or similar. In a preferred embodiment this viewer orientation information relates to the orientation of the viewer's head, eyes or other body parts as they are viewing the device and any movement they may make in the process of viewing footage.

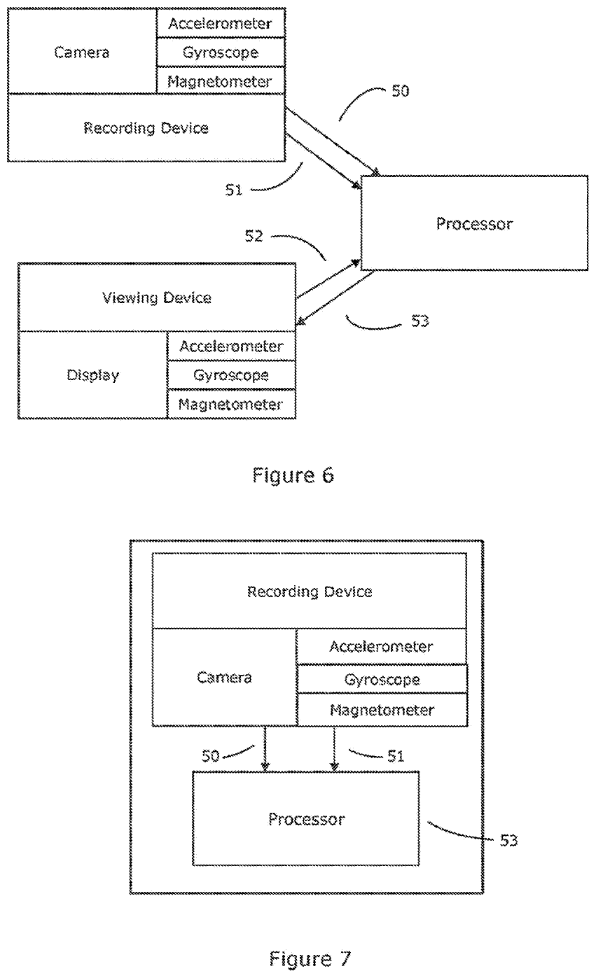

FIG. 6 shows a recording device and a viewing device connected by a common processor. The recording device passes recorded visual information 50 from the camera and orientation information 51 measured by the sensors to the processor. The viewing device passes viewer orientation information 52 measured by the sensors of the viewing device to the processor. The processor then uses this data, as described below/above to align the visual information received 50 to the orientation of the viewing device, such that it outputs visual information which is consistently oriented respective to the orientation of the viewing device, no matter what movement the recording device makes.

FIG. 7 shows the device comprising a recording device having a camera for recording visual information, and a plurality of sensors, preferably a combination of one or more accelerometer(s), gyroscope(s) and magnetometer(s). The recording device passes recorded visual information 50 from the camera and orientation information 51 measured by the sensors to the processor. The processor, as is described above/below, outputs visual information which is consistently aligned to an initial reference orientation, no matter what movement the recording device makes.

Visual information 50 and orientation information 51 are sent to the processor from the recording device. The processor can then combine the visual information 50 and orientation information 51. The processor does not need to be onboard the recording device, but may be. The processor may also receive the viewer orientation information 52 from the viewing device, which will allow the processor to output the aligned visual information 53 to the viewing device. Alternatively the viewing device may have an independent processor for aligning the visual information.

This viewer orientation information 52 is passed, preferably in real time, to a processor associated with either the recording device, the viewing device, or another device, such as an external processor based on a remote server, or externally connected processing computer.

The processor is preferably configured as previously described to stitch the received visual information 50 such that it stays aligned with a set reference no matter the orientation of the recording device. However with the use of the viewing device, the processor preferably receives said viewer orientation information 52 and uses the viewer orientation information 52 to set the reference point, so that the viewer is able to select the reference point which the output visual information is aligned with through their movements.

Preferably, the output visual information 53 will constantly be aligned with where the viewer is directed, no matter the orientation of the recording device. The output visual information which is shown to the viewer through the viewing device is preferably aligned with the viewer orientation information 52 relative to the viewer's preferred orientation as defined by the viewing information.

In an additional embodiment, the processor is adapted to output video information having a reduced field of view such as those commonly associated with conventional camera systems. This can be beneficial for applications requiring real time processing of video wherein the processor being used is unable to provide the requisite processing power to analyse video information and orientation data and stitch the full field of view of the 360 degree footage. In particular, relevant sub-frames having a reduced field of view may be extracted from each frame of 360 degree video information to generate output video information that follows the orientation information provided by the viewing device. In this way, the processor is only analysing and correcting video information pertaining to the field of view the viewer is currently viewing using the viewing device, as will be known from the viewer orientation data. Preferably, the field of view of the output video is equal to the field of view of the projection or screen of the viewing device, which can be transmitted from the viewing device to the processor as a part of the viewer orientation information 52. The processor will preferably receive the visual information and corresponding orientation data from a recording device or external source, and the viewer orientation data from the viewing device. The processor will use the viewer orientation data to extract relevant sub-frames having reduced field of view from the received visual information, the relevant sub frames preferably corresponding to the orientation of the viewing device in relation to the received visual information and initial fixed reference orientation of the recording device. The processor will then preferably be able to use the orientation information received from the recording device to output reduced field of view video information which is fixed to the orientation that the viewer has set using the orientation of the viewing device.

In another embodiment, the processor is adapted to output video information having a reduced field of view such as those commonly associated with conventional camera systems, but without a reference from a viewing device. In order to reduce the amount of processing power required to process visual information, relevant sub-frames having a reduced field of view may be extracted from each frame of 360 degree visual information provided by a recording device or an external source as previously described. The processor preferably generates output video information that is aligned with the initial reference orientation, and having a reduced field of view which is aligned to an initial set orientation of the recording device. This initial orientation can be set by the recording device, the processor or by a viewer.

### Example Use Cases

1. In one embodiment, a single recording can cater to the needs and self-interest of multiple viewers. The recorded environment is neutral. This is achieved by supplying an output footage which is initially set to show footage at an initial datum, and does not track an object, scene, or individual—but an orientation. In order to generate output video that is relevant to each viewer, multiple viewers can be viewing in at the exact same time and decide on what (direction/orientation) to focus their attention on, which may be different to each other. This creates an experience that is different for everyone, all from a single recording.

2. In another embodiment, a person who is wearing the 360 recording device that is fixed onto a headgear is walking down a street and recording their environment. They turn their head left and right, looking at objects of interest. When the viewer watches the output video, the output video does not show the recorded footage turning left and right; instead it is a steady video or image that is in translatory motion moving forward towards the walker's destination. The viewer can then choose to turn their head left and right to view objects that are of interest to them.

3. In a particular embodiment of a community-based platform, a single person recording the neutral environment can share their output video with a wide audience, with each audience taking away a different experience from participating in the output video.

A power source 36 may provide electrical power to an element that may require electrical power and to any other electronic device or electronics that may optionally be in electrical communication with a processing unit 21 (FIGS. 4 and 5). A power source 36 may be a battery such as a lithium ion battery, nickel cadmium battery, alkaline battery, or any other suitable type of battery. In further embodiments, a battery compartment 13 (FIG. 1) may be used to secure a rechargeable or non-rechargeable power source 36 which may or may not be removable from the battery compartment 13. In further embodiments, a battery compartment 13 may be used to secure a rechargeable power source 36 that may be charged by a battery charging element 15 such as a kinetic or motion charging, or by inductive charging, solar power, or other wireless power supply.

A control input 37 may be configured to modulate the functions of any of the input/output interfaces and/or to control power to the device 100 as a whole. In preferred embodiments, a control input 37 may comprise a button or a switch. In other embodiments, a control input 37 may comprise one or more viewer control inputs such as turnable control knobs, depressable button type switches, capacitive type buttons, a mouse, a keyboard, a joystick, slide type switches, rocker type switches, or any other suitable input that may be used to modulate the functions of any of the input/output interfaces and/or to control power to the device 100.

A female plug member 38 may optionally be configured to provide electrical power to a power source 36 and/or the female plug member 38 may be configured to provide electrical communication with the data store 24 (FIG. 5), memory 25 (FIG. 5), processor 22 (FIG. 5), radio 23 (FIG. 5), or any other element of the device 100. In some embodiments, visual information and orientation information recorded by the device 100 may be output from the device 100 through a female plug member 38. A female plug member 38 may also be configured to edit, change, or otherwise update the operating system (O/S) 27 (FIG. 4) and/or the programs 28 (FIG. 4) on the device 100. In preferred embodiments, a female plug member 38 may comprise a USB connector such as a micro-USB or mini-USB. In other embodiments, a female plug member 38 may comprise a Type A USB plug, a Type B USB plug, a USB Type C plug, an Ethernet plug, a HDMI plug, a Mini-A USB plug, a Mini-B USB plug, a Micro-A USB plug, a Micro-B USB plug, a Micro-B USB 3.0 plug, a ExtMicro USB plug, a Lightning plug, a 30-pin dock connector, a Pop-Port connector, a Thunderbolt plug, a Firewire plug, a Portable Digital Media Interface (PDMI) plug, a coaxial power connector plug, a barrel connector plug, a concentric barrel connector plug, a tip connector plug, or any other plug, connector, or receptacle capable of electrical communication with an electronic device.

A microphone 39 may be configured to pick up or record audio information from the environment around the device 100. In preferred embodiments, a microphone 39 may be configured to provide binaural recording of sound so as to create a 3-D stereo sound sensation for the listener. In some embodiments, a microphone 39 may comprise any acoustic-to-electric transducer or sensor that converts sound in air into an electrical signal. In further embodiments, a microphone 39 may comprise any type of microphone such as electromagnetic induction microphones (dynamic microphones), capacitance change microphones (condenser microphones), and piezoelectricity microphones (piezoelectric microphones) to produce an electrical signal from air pressure variations.

Audio collected from the multi-directional microphone is also recorded to be in sync with the recorded neutral environment. In principle, the stitching of audio works in the same way as how the firmware processes and stitches images to create a video.

A light emitting element 40 which may be configured to illuminate areas in the environment with various forms and wavelengths of light so as to facilitate recording by the one or more cameras 31. In some embodiments, a light emitting element 40 may comprise one or more light emitting diodes (LEDs) which may be configured to provide light of various wavelengths and intensities. In other embodiments, a light emitting element 40 may comprise an organic light-emitting diode (OLED), incandescent light bulb, fluorescent light, bulb halogen light bulb, high-intensity discharge light bulb, laser light emitter, electroluminescent light source, neon light source, or any other type of suitable light source.

An indicator element 41 may be configured to apprise a viewer of the device 100 of the status of one or more I/O interfaces 30 and/or the status of the device 100 such as if they are powered on and the like. In other preferred embodiments, an indicator element 41 may be configured to apprise a viewer of the device 100 of the status or charge level of a power source 36. To provide information to a viewer, embodiments of an indicator element 41 can be visually implemented with one or more light emitting elements or other display device, e.g., a LED (light emitting diode) display or LCD (liquid crystal display) monitor, for displaying information. Other kinds of indicator element 41 devices can be used to provide for interaction with a viewer as well; for example, feedback provided to the viewer can be any form of sensory feedback, e.g., visual feedback, auditory feedback, or tactile feedback; and input from the viewer can be received in any form, including acoustic, speech, or tactile input.

A memory card reader 42 may be configured to receive data from a processing unit 21 or any other element of the device 100 and to electrically communicate the data to a removable storage device such as a memory card. In preferred embodiments, a memory card reader 42 may comprise a microSD memory card reader that is configured to receive a microSD memory card and to read and write data to the microSD memory card. In other embodiments, a memory card reader 42 may comprise a memory card reader that is configured to receive and to read and write data to a memory card such as a PC Card memory card, CompactFlash I memory card, CompactFlash II memory card, SmartMedia memory card, Memory Stick memory card, Memory Stick Duo memory card, Memory Stick PRO Duo memory card, Memory Stick PRO-HG Duo memory card, Memory Stick Micro M2 memory card, Miniature Card memory card, Multimedia Card memory card, Reduced Size Multimedia Card memory card, MMCmicro Card memory card, P2 card memory card, Secure Digital card memory card, SxS memory card, Universal Flash Storage memory card, miniSD card memory card, xD-Picture Card memory card, Intelligent Stick memory card, Serial Flash Module memory card, p card memory card, NT Card memory card, XQD card memory card, or any other removable memory storage device including USB flash drives.

FIG. 5 illustrates a block diagram showing an example processing unit 21 which may be a component of a neutral environment recording device 100 according to various embodiments described herein. In some embodiments and in the present example, the device 100 can be a digital device that, in terms of hardware architecture, comprises a processing unit 21 which generally includes a processor 22, input/output (I/O) interfaces 30, an optional radio 23, a data store 24, and memory 25. The components and elements (22, 30, 23, 24, and 25) are communicatively coupled via a local interface 26. The local interface 26 can be, for example but not limited to, one or more buses or other wired or wireless connections, as is known in the art. The local interface 26 can have additional elements, which are omitted for simplicity, such as controllers, buffers (caches), drivers, repeaters, and receivers, among many others, to enable communications. Further, the local interface 26 may include address, control, and/or data connections to enable appropriate communications among the aforementioned components.

In preferred embodiments, the processing unit 21 may combine visual information from one or more cameras 31 with orientation information from a magnetometer 32, gyroscope 33, GPS sensor 34, and/or accelerometer 35. The processing unit 21 may align and stitch each frame recorded by the cameras 31 by aligning cardinal direction (North, East, South, West) provided through orientation information, as previously described. However the device 100 rotates or is moved, the recorded footage will be processed by the processing unit 21 to keep true to its cardinal direction, as measured by the magnetometer(s) and keep the saved footage parallel with the ground, as determined by the accelerometer(s) and the gyroscope(s). In alternative embodiments, orientation information and visual information recorded by the device 100 may be processed and combined by a further processor that is separate from the device 100.

The processor 22 or the further processor is preferably a hardware device for executing software instructions. The processor 22 can be any custom made or commercially available processor, a central processing unit (CPU), an auxiliary processor among several processors associated with the processing unit 21, a semiconductor-based microprocessor (in the form of a microchip or chip set), or generally any device for executing software instructions. When the processing unit 21 is in operation, the processor 22 is configured to execute software stored within the memory 25, to communicate data to and from the memory 25, and to generally control operations of the device 100 pursuant to the software instructions. In an exemplary embodiment, the processor 22 may include a mobile optimized processor such as optimized for power consumption and mobile applications. The I/O interfaces 30 can be used to receive and record visual and orientation information, to receive viewer input from a control input 37, and/or for providing output through an indicator element 41, female plug member 38, and memory card reader 42. The I/O interfaces 30 can also include, for example, a serial port, a parallel port, a small computer system interface (SCSI), an infrared (IR) interface, a radio frequency (RF) interface, a universal serial bus (USB) interface, and the like.

An optional radio 23 enables wireless communication to an external access device or network. Wireless communication is preferably used to transmit and receive information relating to the processes as described. Preferably, the wireless communication is used to receive visual information and/or orientation information from an external recording device or a further processor, for use by the processor. For example this information could be streamed or downloaded wirelessly directly from a recording device, or else streamed or downloaded from an external processor such as a wireless storage device, or remote servers through the cloud. The wireless communication can also be used for communication with one or more viewing devices, wherein the wireless communication stream is used to receive viewer orientation data and transmit outputted visual information to the viewer. The wireless communication and processor are preferably adapted to communicate information in real time such that viewer orientation information 52 is passed to the processor and the processor is able to provide back the viewing device the processed output visual information with low latency. Preferably the viewer of the viewing device is able to control the frames being viewed with low enough latency that in as close to real time as possible. In some embodiments, a radio 23 may operate through cellular, Wi-Fi, and/or Bluetooth bands and communication protocols. Any number of suitable wireless data communication protocols, techniques, or methodologies can be supported by the radio 23, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Near-Field Communication (NFC); Frequency Hopping Spread Spectrum; Long Term Evolution (LTE); LTE Advanced; cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication.

The data store 24 may be used to store data, such as recorded visual information and orientation information, viewer orientation information, and output visual information such as output viewer video. The data store 24 may include any of volatile memory elements (e.g., random access memory (RAM, such as DRAM, SRAM, SDRAM, and the like)), non-volatile memory elements (e.g., ROM, hard drive, tape, CDROM, and the like), and combinations thereof. Moreover, the data store 24 may incorporate electronic, magnetic, optical, and/or other types of storage media. The data stored may later be downloaded from the device, or alternatively be streamed to another device for use elsewhere, such as on a viewing device.

The memory 25 may include any of volatile memory elements (e.g., random access memory (RAM, such as DRAM, SRAM, SDRAM, etc.)), non-volatile memory elements (e.g., ROM, hard drive, etc.), and combinations thereof. Moreover, the memory 25 may incorporate electronic, magnetic, optical, and/or other types of storage media. Note that the memory 25 may have a distributed architecture, where various components are situated remotely from one another, but can be accessed by the processor 22. The software in memory 25 can include one or more software programs, each of which includes an ordered listing of executable instructions for implementing logical functions. In the example of FIG. 4, the software in the memory system 25 includes a suitable operating system (O/S) 27 and programs 28.

The operating system 27 essentially controls the execution of input/output interface 30 functions, and provides scheduling, input-output control, file and data management, memory management, and communication control and related services. The operating system 27 may be, for example, LINUX (or another UNIX variant), Android (available from Google), Symbian OS, Microsoft Windows CE, Microsoft Windows 7 Mobile, iOS (available from Apple, Inc.), webOS (available from Hewlett Packard), Blackberry OS (Available from Research in Motion), and the like.

The programs 28 may include various applications, add-ons, etc. configured to provide end user functionality with the device 100. For example, exemplary programs 28 may include, but not limited to, environment variable analytics and modulation of I/O interface 30 functions. In a typical example, the end user typically uses one or more of the programs 28 to record and/or process visual information provided with one or more cameras 31 and orientation information provided by one or more magnetometers 32, gyroscopes 33, GPS sensors 34, and/or accelerometers 35.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

The processing unit 21 may also include a main memory, such as a random access memory (RAM) or other dynamic storage device (e.g., dynamic RAM (DRAM), static RAM (SRAM), and synchronous DRAM (SDRAM)), coupled to the bus for storing information and instructions to be executed by the processor 22. In addition, the main memory may be used for storing temporary variables or other intermediate information during the execution of instructions by the processor 22. The processing unit 21 may further include a read only memory (ROM) or other static storage device (e.g., programmable ROM (PROM), erasable PROM (EPROM), and electrically erasable PROM (EEPROM)) coupled to the bus for storing static information and instructions for the processor 22.

While some materials have been provided, in other embodiments, the elements that comprise the device 100, such as the body 11 and/or any other element discussed herein, may be made from durable materials such as aluminium, steel, other metals and metal alloys, wood, hard rubbers, hard plastics, fiber reinforced plastics, carbon fiber, fiber glass, resins, polymers or any other suitable materials including combinations of materials. Additionally, one or more elements may be made from or comprise durable and slightly flexible materials such as soft plastics, silicone, soft rubbers, or any other suitable materials including combinations of materials. In some embodiments, one or more of the elements that comprise the device 100 may be coupled or connected together with heat bonding, chemical bonding, adhesives, clasp type fasteners, clip type fasteners, rivet type fasteners, threaded type fasteners, other types of fasteners, or any other suitable joining method. In other embodiments, one or more of the elements that comprise the device 100 may be coupled or removably connected by being press fit or snap fit together, by one or more fasteners such as hook and loop type or Velcro® fasteners, magnetic type fasteners, threaded type fasteners, sealable tongue and groove fasteners, snap fasteners, clip type fasteners, clasp type fasteners, ratchet type fasteners, a push-to-lock type connection method, a turn-to-lock type connection method, slide-to-lock type connection method or any other suitable temporary connection method as one reasonably skilled in the art could envision to serve the same function. In further embodiments, one or more of the elements that comprise the device 100 may be coupled by being one of connected to and integrally formed with another element of the device 100.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

1-47. (canceled)

48. A neutral environment recording device, the device comprising:
a) a camera configured to record images or video as visual information;
b) a gyroscope sensor configured to measure and communicate position data, orientation data, position change data, and/or orientation change data describing the device as orientation information;
c) a magnetometer configured to measure the direction of the earth's magnetic field at a point in space occupied by the device as orientation information;
d) an accelerometer configured to measure and provide acceleration data; and
e) a processing unit in communication with the camera, gyroscope, magnetometer, and accelerometer, wherein the processing unit is configured to record visual information provided by the camera, wherein the processing unit is configured to record orientation information and data provided by the gyroscope, magnetometer, and accelerometer, and wherein the processing unit is configured to combine the visual information and orientation information so an output visual information has respective orientation information related to it, the processing unit storing the output visual information aligned to an initial reference orientation.

49. The neutral environment recording device of claim 1, Wherein the processing unit stores the output visual information aligned to an initial reference orientation on the device or associated memory.

50. The neutral environment recording device of claim 1, Wherein the processing unit streams from the device the output visual information aligned to an initial reference orientation.

51. The neutral environment recording device of claim 1, wherein the output visual information is aligned to an initial reference orientation.

52. The neutral environment recording device of claim 1, wherein the output visual information has a field of view aligned to an initial reference orientation.

53. The neutral environment recording device of claim 1, wherein a field of view of the output visual information stays aligned to an initial reference orientation, irrespective of the orientation of the recording device at the time of recording.

54. The neutral environment recording device of claim 1, wherein the output visual information is streamed or stored with a field of view aligned to the initial reference orientation.

55. The neutral environment recording device of claim 1, wherein the output visual information is shifted or stitched to stay aligned to the initial reference orientation.

56. The neutral environment recording device of claim 1, wherein an initial reference orientation is a first orientation of the visual information recorded, streamed or output to a viewer.

57. The neutral environment recording device of claim 1, wherein orientation information is used to determine the difference of orientation between the recorded visual information and the initial reference orientation.

58. The neutral environment recording device of claim 1, wherein position data, orientation data, position change data, and/or orientation change data is used independently or with the magnetometer orientation information to determine the difference of orientation from the recorded visual information to the initial reference orientation.

59. The neutral environment recording device of claim 1, wherein a viewer of the output visual information can choose to view output visual information relating to a new reference orientation, the new reference orientation having a change of orientation from the initial reference orientation.

60. The neutral environment recording device of claim 1, wherein the viewer views the output visual information on a projection or screen.

61. The neutral environment recording device of claim 1, wherein a field of view of the output visual information is equal to the field of view of the projection or screen.

62. The neutral environment recording device of claim 1, wherein a new reference orientation is determined by the shift in orientation of a viewer's head from an initial reference orientation.

63. The neutral environment recording device of claim 1, wherein the output visual information is shifted or stitched to stay aligned to a new reference orientation.

64. The neutral environment recording device of claim 1, wherein the orientation information is combination at least a horizontal orientation and a vertical orientation from the magnetometer.

65. The neutral environment recording device of claim 1, wherein any drift, noise or error in the magnetometer orientation information is able to corrected or trued by the orientation information from the gyroscope or accelerometer, where the gyroscope or accelerometer data may include any one or more of position data, orientation data, position change data, orientation change data and acceleration data.

66. The neutral environment recording device of claim 1, wherein the processing unit or further processor corrects roll, pitch and yaw to output a. stable and cardinally constant output video with associated orientation information.

67. The neutral environment recording device of claim 1, wherein the processing unit or further processor corrects roll, pitch and yaw to output a stable and cardinally constant output viewer video aligned to the viewer's preferred orientation.
